(19) United States
(12) Patent Application Publication
(10) Pub. No.: US 2009/0053060 A1
(43) Pub. Date: Feb. 26, 2009

(54) Wind turbine blade control system

(76) Inventor: Theodore M. Garver, Springboro, PA (US)

Correspondence Address: Fay Sharpe LLP, 1228 Euclid Avenue, 5th Floor, The Halle Building, Cleveland, OH, 44115-1843, US

(21) Appl. No.: 12/157,104

(22) Filed: Jun. 5, 2008

Related U.S. Application Data
(60) Provisional application No. 60/933,325, filed on Jun. 6, 2007.

(51) Int. Cl. F03D 7/02

(52) U.S. Cl. 416/23; 416/37; 416/1

(57) ABSTRACT

Wind turbines or generators are provided with a larger operating range, and made more efficient through the use of controlling the Bernoulli Effect on air foil blades. The control is effected through the use of rotating bands arranged over at least part of the surface of the blades. The direction of the moving bands is reversible so as to increase or decrease the lift provided by the Bernoulli Effect. In the present invention, greater torque can be developed on the wind generator without increasing the wind speed.

### PRIORITY INFORMATION

The present invention claims priority to Provisional Patent Application No. 60/933,325 filed on Jun. 6, 2007.

### FIELD OF INVENTION

The invention relates, in general, to wind turbines, fans and general turbines used for converting usable mechanical energy to electrical power. The mechanical energy is derived from natural wind and water energy. The present system is used to generate electrical power on as constant a basis as possible by increasing the effectiveness and operating range of wind turbines.

### BACKGROUND ART

The necessity of using natural wind energy has been historically apparent, at least until the age of massive fossil fuel combustion. Fossil fuels have motivated the development of the superheated steam generator, which has become the mainstay for electrical power generation for the last century. Because of this reliance, development of technologies using natural wind power has suffered from neglect.

However, the increasing costs of the massive use of fossil fuel combustion-generation electricity have become unavoidable. These costs are not just present economic matters, but include massive environmental deterioration. Alternatives, such as wind-driven electrical power generation, have now become not only viable, but also necessary.

Windmills, used to convert wind energy to usable mechanical energy, have always had their particular set of problems and drawbacks. Traditional windmills (drag type) have used flat blades or sails that would catch the wind and turn a drive shaft. Mechanical energy from the drive shaft would be transmitted through 90 degree gear arrangements and transferred to a point where the mechanical energy was desired, such as a grinding mill. Clearly, this was a useless arrangement when there was not enough wind to catch the sails and turn the drive shaft. Also, too much wind is also very problematical.

The use of wing-like (lift type) blades in place of sails proved to be an improvement due to long-unrecognized aerodynamic forces inherent to air foil wing design. However, major drawbacks still exist due to conditions of too little wind or too much wind. Also, traditional windmill structures are very vulnerable. There is a wide range of questionable mechanical characteristics that could easily result in the incapacity, or even destruction of the overall windmill structure.

In more recent times, windmills have evolved into wind turbines having drag type blades. Each of these blades is constituted by an air foil, and has a twisted leading edge to better take advantage of aerodynamic forces, thereby raising the efficiency of the overall system. Standard wind turbine blades have leading edges that twist along the length of the blade for more powerful lift effects as the blade rotates. While advanced mechanical features have made such systems far more reliable than historic windmills, there are still many serious disadvantages when considered for use in reliable electrical power generation. For example, there is an unacceptably high cost per kilowatt hour when the construction, maintenance, and above all, repair costs, of wind turbines are considered. Wind turbines require considerable room in which to operate (especially when compared to comparable fossil fuel combustion generators). Wind turbines are always vulnerable to the environment and can be incapacitated or even destroyed by ice storms, heavy snows, high winds and electrical activity.

Even if these dangers did not exist, there are still certain mechanical drawbacks, even when a wind turbine is operating at high efficiency. In particular, the tip of the blade moves at an extremely high velocity (increasing as blades increase in length) creating substantial mechanical stresses that would ultimately lead to breakdown, even if all environmental effects proved to be benign. Vibrations caused by the fast-moving blade tips result in oscillations, and eventually in destructive resonances. High speed also exacerbates the normal mechanical wear found in any rotating system.

All of the aforementioned effects exacerbate the chief limitation of wind generators: a limited operating range of wind velocities. A number of the mechanical difficulties inherent to wind generators have been addressed in U.S. Pat. Nos. 4,366,386 to Hanson, and No. 5,730,581 to Buter, et al., both incorporated herein by reference. While substantial improvements have been effected by the systems of both these patents, the problems with limited operating ranges still remain. Further, the improved systems of both of the cited patents introduce additional complexities to wind generator systems, and thus, additional problems. In particular, the two cited systems have done little to expand the operational wind velocity range of twisted blade type conventional wind generators.

Accordingly, the conventional art of wind generating admits to a drastic need to increase the power generated and to expanded operating wind speed ranges. An improved system would also provide greater mechanical strength, while limiting additional complexity.

### SUMMARY OF INVENTION

Accordingly, it is a primary goal of the present invention to improve wind generator operation over the operation of conventional wind turbines.

It is another object of the present invention to increase the upper and lower operating wind velocity ranges of wind turbines.

It is a further object of the present invention to increase the overall power capacity and efficiency of wind turbines.

It is an additional object of the present invention to permit a wind turbine to operate at greater wind speeds than conventional, twisted blade wind turbines.

It is still another object of the present invention to operate a twisted blade wind turbine with reduced mechanical deterioration.

It is again a further object of the present invention to limit additional mechanical complexities to be added to improvements in wind turbine systems.

It is yet an additional object of the present invention to provide a wind turbine operating at a lower cost per kilowatt hour than conventional wind turbines.

It is yet another object of the present invention to provide a twisted blade wind turbine that is more storm-resistant than conventional twisted blade wind turbines.

It is again a further object of the present invention to provide an improved wind turbine while maintaining a conventional twisted edge blade design.

It is still an additional object of the present invention to provide a wind turbine having increased efficiency and greater power transfer for a twisted edge blade.

It is yet another object of the present invention to improve the performance of any industrial air mover, or turbine, including steam and hydraulic turbines.

It is again a further object of the present invention to provide an improved technique for operating wind generators.

It is still a further object of the present invention to provide a wind generator that can generate greater torque and thus power without increasing the speed of the generator blades.

It is yet an additional object of the present invention to provide a wind turbine that can accommodate different environmental conditions along the length of the turbine blades.

These and other goals and objects of the present invention are provided by a wind turbine having a twisted leading edge blade design, and ______ on air foil. The blade has structure for adjusting Bernoulli Effect forces on the air foil.

In yet another aspect of the present invention, method of operating a wind turbine having a twisted leading edge multiple blade design, includes the steps of rotating said blades about a central nacelle so that each blade constitutes an air foil driven by wind impacting the turbine. The lift characteristics of said air foils are controlled without adjusting wind speed.

### BRIEF DESCRIPTION OF DRAWINGS

FIG. 1 is a front view of a wind turbine, constituting one environment in which the present invention can operate.

FIG. 2 depicts the present invention as it is configured to fit onto one of the turbine blades of FIG. 1.

FIG. 3 depicts another variation of the present invention as it is applied to the turbine blades of FIG. 1.

FIG. 4 depicts a side view of an interior mechanism for operating the present invention within a segment of one of the turbine blades of FIG. 1.

FIG. 5 is an additional embodiment of the present invention, including a support structure to accommodate high speed operation of the turbine blades.

FIG. 6 depicts an interface structure between the turbine blades and the support structure depicted in FIG. 5.

FIG. 7 is a cutaway top view of a blade depicting a moving band and supporting rollers.

FIG. 8 is a side view of a ball bearing arrangement used to interface between a blade and a moving band.

### DETAILED DESCRIPTION OF PREFERRED EMBODIMENT

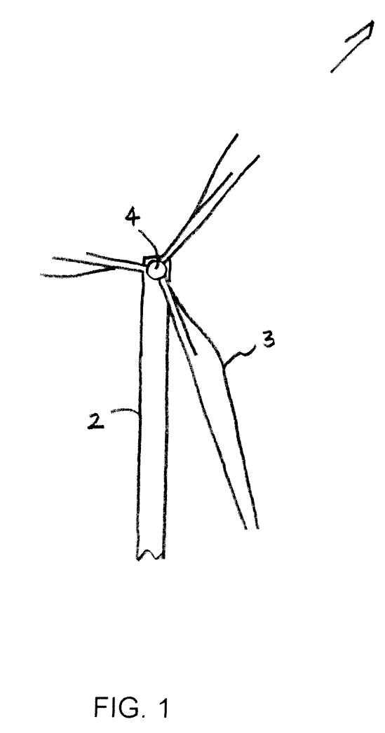

One preferred embodiment of the present invention is applied to wind turbine or generator 1 in FIG. 1. Conventional wind generator design includes twisted edge blades (3), joined by a conventional nacelle or hub structure (4), which includes the entire drive shaft and gear configuration. The nacelle (4) can also include a conventional electrical power transference arrangement (not shown), using brushes so that electrical power can be transmitted along blades (3), for lighting and the like.

Since winds are variable, modern wind turbines include a nacelle (4), which can be pivoted so that the blades (3), are pointed at an optimum direction with respect to wind direction to fully take advantage of wind speed. All of this is conventional technology and merely constitutes the environment in which the present invention will operate.

The blades of the wind turbine do not constitute the only environment in which the present invention made be operated. For example, the present invention can be used on the blades of industrial fans, such as induction draft fans for use in steel mills, or cooling tower applications. Additional uses are possible, including helicopter blades and the fan blades of ground effect vehicles, or fans used for vehicle propulsion. The present invention can also be applied to steam and hydraulic turbine fan blades.

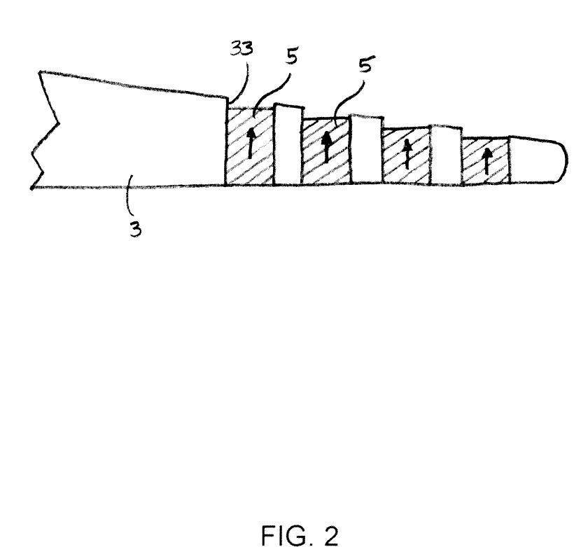

The first preferred embodiment of the present invention is depicted in FIG. 2 in the form of moving bands (5), applied to the outer surface of a blade (3), as depicted in FIG. 1. Turbine blade (3) is a conventional twisted edge blade. In FIG. 1, this blade (3) is depicted as a relatively flat structure with an even leading edge (31). Rather than depict the complex twists of a conventional wind generator blade, leading edge (31) has been shown as a straight line. This is done to facilitate understanding of the structure of the invention.

It is expected that the moving bands (5) will be made out of mylar, or a similar material, and will follow the entirety of the contour of the cross section of blade (3). Bands (5) move best when they are of a uniform width over the entire length of the band and a uniform length across the entire width of the band. This permits an even, regular movement which is easy to regulate, and obtain the benefits of the present invention such as controlling lift along the length of blade (3).

Modern turbine blades (3) have twisted leading edges, and are formed in a shape appropriate to constitute air foils. The twisted leading edge (31) (in FIG. 2) is configured so as to maximize air foil capabilities when the blade (3) rotates about hub or nacelle (4). Also, because of dynamic requirements due to the increased speed of a rotating blade (3) towards the distal end (opposite the nacelle (4)), the blade, the cross section of blade (3) typically alters along its length. Consequently, the mounting of rotating bands (5), even in relatively small segments, can be somewhat problematical.

In order to maintain a uniform width for each of the moving bands (5), as well as uniform length, the blade (3) has to be locally contoured or sculpted to form grooves having sidewalls (33) and front surfaces (32). Fortunately, as depicted in some of the cited conventional art, the manipulation or sculpting of wind generator blades is well within the capabilities of those skilled in this particular art.

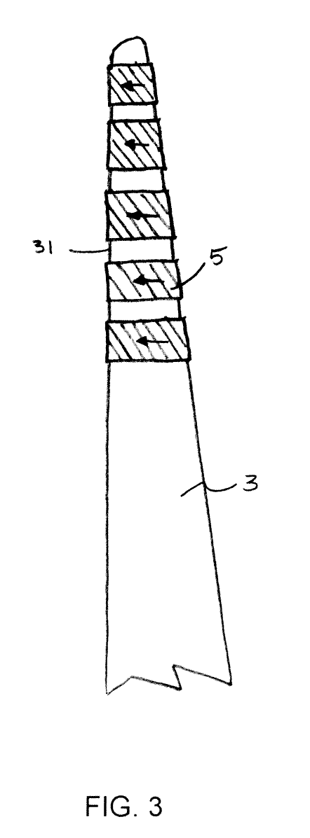

FIG. 3 depicts an alternative to FIG. 2. In this variation, the bands are not necessarily of uniform width along their entire lengths, or of uniform length along the entire widths. This is because the bands have to be configured to fit the shape of blade (3) rather than the blade being configured with grooves to accommodate the moving bands (5). This can lead to some difficulty in controlling the movement of bands (5). Many variations of this embodiment can be used within the concept of the present invention.

However, easier control for the moving bands (5) is achieved with the embodiment depicted in FIG. 2 where the blade (3) is notched and configured to allow each band to be of equal width across its entire length. This arrangement also facilitates efficiency since driving the bands is much easier. Further, control of the speeds and the capability of reversing the bands is also facilitated by the embodiment of FIG. 2.

Both of the embodiments (with and without contoured notches on blade (3)) have drawbacks. Notching or otherwise configuring blade (3) permits uniform operation of each of the bands (5). However, the process of notching changes the characteristics of the overall air foils constituted by blade (3), which might not work as well as an air foil due to the notches or other contouring. The process of contouring blade (3) also renders the overall wind turbine (1) more expensive than a conventional, unmodified turbine. On the other hand, the changing attack angle (of leading edge (31)), as well as the changing cross section along the length of blade (3) presents substantial problems in maintaining smoothly moving bands (5) even if these are arranged in very narrow, individual pieces. The greater the number of individual moving bands (5), the greater the manufacturing costs and the complexity of the driving system which must be geared separately for each of the bands (5). Clearly, some sort of interface is needed between the irregular surface of blade (3) and the regular path of travel desired for each of the moving bands (5).

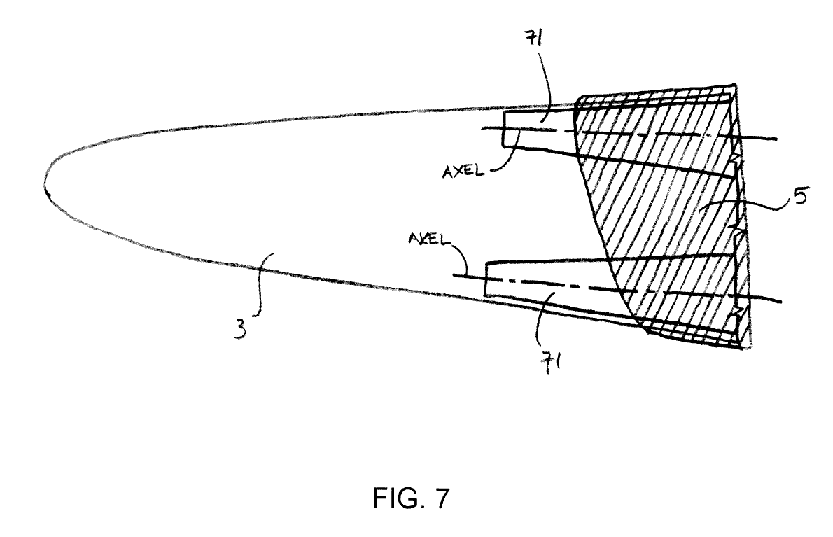

One solution is the use of rollers (71) between the irregular surface of blade (3) and the desired path of travel of rotating band (5). This can be accomplished with a number of different structures. For example, the rollers (71) need not be of uniform shape and size. Rather, one end can have a much larger diameter than the other end. Further, the diameter at the two ends of a roller (71) could be substantially smaller than the diameter in the middle of the roller. The sizes and shapes of roller (71) can be as simple as that depicted in FIG. 7, or as complex as any possible configuration of rotating bands (5) might suggest. Further, the rollers, even asymmetrical rollers can be directly driven, so as to serve as both motivators and interface for the rotating bands (5).

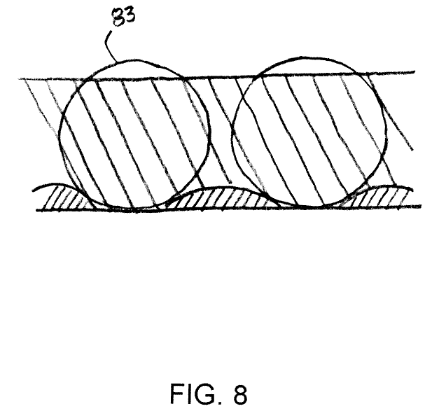

However, rollers (71) are not the only interface that can be used between the irregular surface of blade (3) and the desired path of the rotating band (5). As depicted in FIG. 8, ball bearing structure (8) can be used as part of the interface between the blade (3) and the desired path of moving band (5). Ball bearing structure (8) is depicted as being constituted by two side frames (81) and a bottom piece (82). These contain roller balls (83) between the blade surface (3) on which the ball bearing structure (8) is mounted and moving band (5). Because of the nature of ball bearings easy movement in almost any direction is facilitated for the moving band (5). Ball bearing structure (8) can therefore accommodate irregular band shapes far more easily than contoured rollers (71). Also, the ball bearing structure (8) can be arranged in any configuration appropriate to provide a moving interface between the blade surface (3) and the desired path of the moving band (5). The ball bearing structures (8) can be placed virtually anywhere on the blade (3), and in any desirable configuration to facilitate easy movement between the moving bands (5) and the surface of blade (3).

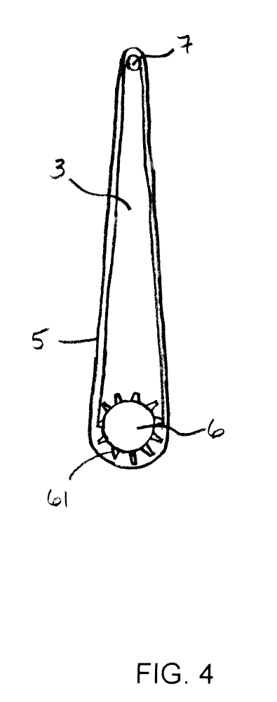

It should be understood that any cross sectional shape of blade (3) can be used to support the moving band (5). For example, the wedge shape depicted in FIG. 4 is not absolutely necessary for the concept of the present invention to operate. Rather, any number of different shapes can be used for the operation of moving band (5). However, the optimum design of the preferred embodiment is that depicted in FIG. 4.

The bands are driven in an arrangement as depicted in FIG. 4. FIG. 4 depicts a cross sectional view of a segment of blade (3), as it has been reshaped to accommodate the moving band (5). The final contour followed moving band (5) around the reshaped segment of blade (3) is selected for maximum efficiency in moving the band both forwards and backwards. Pivot (7) is attached to the edge of blade segment (3) so as to form a rotating point around which the moving band (5) can travel.

The drive for the movement of band (5) is provided by motivator (6), which preferably includes a reversible electric motor, drive shaft and appropriate gearing (not shown). A grasping structure (61) extends from either the drive shaft or appropriate drive wheels to help hold the interior of the moving band (5), and drive it in either direction. A reversible electric motor (not shown) is driven from low voltage DC lines (not shown) that run through or along the length of blade (3). Connection between these lines and power source is through a conventional electrical brush arrangement (not shown) located at the nacelle or hub (4). Alternatively, the motor can be located at the nacelle, and mechanical power transmitted to the moving bands by flexible shafts and appropriate gearing.

It should also be understood that in one preferred embodiment of the present invention a standard, conventional, twisted edged blade is adapted to the present invention by configuring segments of it to have the shape depicted in FIG. 4 for each segment. Because the leading edge of the blade is twisted, each moving band is also changed in its orientation so as to follow the leading edge of the blade. As a result, each subsequent moving band is rotated in orientation with respect to those bands on either side of it. The bands can also be configured to any shape or orientation of turbine blade or air foil.

Other applications of moving bands are found in U.S. Pat. Nos. 6,322,024, and 6,824,109, both to the inventor of the present application. These are hereby incorporated by reference. Both of these patents illustrate the use of moving bands and their effect on lift for an airfoil. When the band is moving the direction of the wind, lift is increased. When the band is moved opposite the direction of the wind, the lift is decreased. The two subject patents disclose the speed/lift relationships when using the moving bands on an air foil. The subject patents also include disclosures of techniques for moving the bands about an air foil. Many of the techniques described therein are appropriate for the air foil constituted by the turbine blade (3).

With the present invention moving bands (5) are applied to turbine blades (5). When the moving bands (5) are moving in the direction away from the leading edge (31), it has been discovered that the effective torque generated by turbine blade (3) increases. On the other hand, when the direction of the moving bands is towards leading edge (31), the effective torque generated decreases. This means that in one direction, operation of the moving bands will add torque to the blade (3), in effect creating a virtual increase in wind velocity. When in the other direction, the moving bands decrease the torque, in effect decreasing the wind velocity. By using the movement of the bands in both directions, the overall range of wind velocities during which the wind generator can operate will be increased.

As a result, greater practical use, due to extended operating ranges, can be obtained for any wind generator modified in accordance with the present invention. Because of the adjustability of the moving bands along approximately one half (½) the length of each of the blades (3), and the use of individual controls for each of the moving bands, far greater adjustment of the overall system can be made to prevailing weather conditions. Also, adjustments can be made for the increasing speed of the blade (3) near its distal portion. The effective increase through the use of the moving band (5) is to firstly increase the power output for the same amount of wind speed, an increase of approximately 20%. For example, this means that at the low end of the wind velocity operation range, the present invention will be able to operate at four (4) miles per hour rather than seven (7) miles per hour.

In the preferred embodiments, the moving bands (5) will be divided up into a large number of rather narrow structures. While this creates difficulties in providing drives for each individual moving band (5), it also provides flexibility in the operation of the overall system along the length of a blade (3). Conditions nearer the hub of the blade are far different than they are near the distal end, where the speed can be several times that nearer the hub. Consequently, adjustments in the aerodynamic characteristics of turbine blade must be made along the entire length of the blade (3).

In the preferred embodiment of the present invention, the moving bands (5) are mounted to extend for approximately one half (½) of the length of blade (3). Location of the moving bands (5) near the ends of the blades, places them in the area of greatest blade velocity. It has been determined through experimentation and calculation that moving bands are most effective in this area. However, within the concept of the present invention, the moving bands can be placed over virtually the entire length of the blades (3). The moving bands will have the least effectiveness near the nacelle or hub (4), so that there is little economic benefit in locating the bands on the quarter of the fan blade (3) nearest the hub (4).

The moving bands can be altered in their width and spacing in accordance with the size and shape of the fan blade (3). In many cases, the leading edge of the moving band will shift along the length of the blade (3) in accordance with the twist of the leading edge of the blade. It is the changing shape of the blade and changing angle of the leading edge of the blade that necessitate the segmentation of the moving bands. Otherwise, moving bands (5) could be constituted in a single piece with no space lost.

Different shapes of turbine blades (3) will dictate different configurations of moving bands, and the placement of the bands along the fan blades. Use of the moving bands will also determine changes in the shapes of the fan blades so that the moving bands can be accommodated. Because of this flexibility, the present invention need not be limited to the twisted edge blades of a wind turbine or generator. Flat or regular blades are easily accommodated. Further, the present invention can be applied to the rotors of a helicopter, or to turbine fans, or to industrial fans such as those used for air induction in steel mills, or in cooling towers.

In such applications, a reversible, electric motor is not needed since the moving bands (5) will move only in one direction rather than in two directions. Within the concept of the present invention, virtually any kind of air movement device can be improved by the control exerted by segmented bands (5) arranged to conform to the blade (3), which can also be sculpted to accept the most effective configuration of the moving bands. In vertical axis wind generators the blades are conventionally of uniform width without a twist so that the moving band can be applied to the entire blade.

In the realm of energy conversion, ever larger systems are considered desirable to feed ever increasing demand. Accordingly, this is also true in the field of wind-powered electrical generation. This means that wind generators operate at higher speeds to achieve greater power conversion. Part of the first embodiment of the present invention is to increase the speed at which a wind turbine can operate. It should be understood that the speeds at the end of the fan blades are much higher (2-8 times) than those at the nacelle or hub. Consequently, as the wind generator blades become longer, greater speeds and thus, greater physical stresses are introduced to the entire system. The result is that the chances of catastrophic occurrence increase as do the severity of such occurrences. The additional torque provided by the present invention adds to these effects as well. Accordingly, yet another embodiment of the present invention leads to the solution of the complications added by the virtues of the first embodiments.

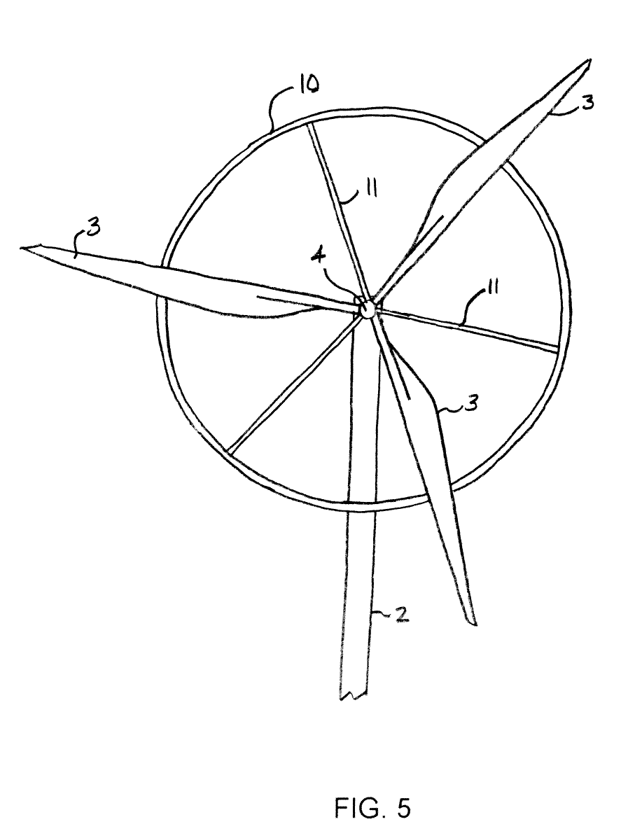

One solution to the problems of increased speed, and the additional dynamic stress is their complications, is depicted in FIG. 5. The wind turbine (1) is the same as that depicted in FIG. 1. However, a support structure has been added. The support structure is constituted by a support ring (10) and supports struts (11). The support struts are connected at the nacelle or hub (4) of the wind generator (1). The support ring (10) is sized so that the ring extends at approximately ⅔ of the length of the blades (3). The support structure is preferably made of some extremely strong material such as steel, titanium, a combination thereof, or the like. Depending upon the size and the weight of the blades (3), the support structure can be sized, and its material selected accordingly.

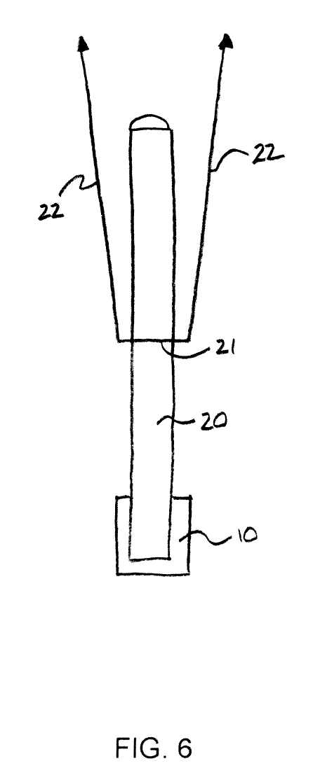

The reason that support structure (10) is in the form of a ring or annular structure, is that generator blades (3) rotate in an annular pattern. In order for ring (10) to serve as a true support, there must be an interface between each of the blades (3) and support ring (10). One such interface is depicted in FIG. 6. The interface is in the form a wheel bearing (20), which fits into the support ring (10), which is formed in a U shape to receive wheel bearing (20). Wheel bearing (20) rotates about an axle (21), which supports connecting struts (22), which are attached at their distal ends to a corresponding point on blade (3).

Although FIG. 6 depicts one interface between support ring (10) and fan blades (3), other interface arrangements can be used. FIG. 6 simply depicts one preferred embodiment. Another arrangement that could be used within the concept of the present invention, would include apertures formed in the blades (3), with the support ring (10) configured to fit through those apertures so that support could be derived for the fan blades by virtue of the support ring bearings or interfaces with the blade apertures. Of course, special provisions must be made for any contact between the ring and the blade surface. Neoprene or nylon bushings are one example of contact surfaces that can be used to constitute this kind of interface between ring (10) and blades (3). Also, the shape of both the aperture and the ring will have to be configured for an optimum interface.

It should be noted that the use of even nylon or other extremely low friction bushings can be problematical due to the speeds and forces involved between turbine blades (3) and support ring (10). However, there is another technique that will keep the blades (3) and support ring (10) from brushing against each other in a catastrophic fashion, absent the bushing of FIG. 6. Extremely high powered magnets can be arranged in the appropriate portions of blade (3) and the appropriate portions of support ring (10). If the magnets are arranged properly, repulsion between identical poles will keep the ring and the blades from ever actually colliding with each other. Use of high powered magnets for maintaining separation under high stress, dynamic conditions has already been fully explored in the art of high speed rail lines, in which magnetic forces keep the train hovering above magnetized rail. Accordingly, additional disclosure regarding this particular technique need not be made for purposes of understanding the present invention.

The support structure, including support ring (10), connected with support struts (11), to the hub (4), renders a structure that is very difficult for rotation to occur at the hub or nacelle (4). Currently, one adaptation to accommodate this embodiment is that the rotation of the generator to select the optimum wind direction be conducted at the base of the tower (2) which supports the wind generator. This structure is not shown in any of the drawings, but would be constituted by a conventional design similar to the design for rotating only the nacelle (4). However, other arrangements can be made so that support struts (11) (and consequently support ring (10)) are moved in exact accordance with the hub (4) and the blades (3). Any conventional technique that will accommodate existing structures and environments can be used to effect the selection of the optimum wind direction for operation.

The present invention can operate to increase the power output of a standard twisted blade wind turbine by approximately twenty percent (20%), or perhaps even more under the correct circumstances. This is done by manipulating the Bernoulli effect upon the turbine blades (3) that normally constitute air foils. This is because the present invention can increase the lift or torque due to the Bernoulli Effect to about five (5) times that of a standard twisted blade turbine without the present invention.

These benefits are based upon measurements taken on a twisted blade wind turbine having a 45° angle of attack and operating where the band speed is approximately equal to the wind speed. Measurements were taken in the normal operating range of between five (5) and fifty (50) miles per hour for standard wind turbines. Additional calculations based upon the characteristics of a twisted blade wind turbine indicate that approximately 20% additional torque or energy will result from the operation of the moving bands (5), rotating at a speed approximately equal to that of the wind speed.

While one standard is to create a smooth, uniform movement of bands (5) around the appropriate portions of the blade (3), this is not always desirable. For example, the stresses and speed of blade (3) change along the length of the blade from the hub (4) to the distal ends. Accordingly, to adjust for maximum efficiency (control of the Bernoulli effect) and stress compensation, the bands (5) at various portions along the length of the blade (3) will operate at different, appropriate speeds. Because of the complexity of such an operation, feedback detectors (not shown) would have to be placed on the blade (3) and the motivators controlled by a feedback responsive computer controller.

A major drawback with standard wind generators is that winds higher than fifty (50) miles per hour render the wind generators inoperable for a number of reasons. However, with the present invention, reversal of the moving bands (5) can keep a wind generator within normal operating range despite wind speed higher than those permitted in the normal operating range. This is because the effective torque is reduced by moving bands (5) in an opposite direction to that shown in the drawings. Tests indicate that control of the Bernoulli effect facilitated by the present invention adds twenty percent (20%) power or torque to the low end of the operating range so that lower wind speeds can be utilized than is possible with conventional wind generators. Likewise, the effective torque can be decreased twenty percent (20%) so that greater wind speeds can be accommodated than those constituting the upper limits of operating ranges for conventional wind generators.

While a number of embodiments have been described by way of example, the present invention is not limited thereto. Rather, the present invention should be construed to include any and all embodiments, variations, permutations, adaptations, and derivations that would occur to one skilled in this art with the teachings of the present invention. Accordingly, the present invention should be limited only by the following claims.

1. A wind turbine including at least one blade having a twisted leading edge and forming an air foil, and comprising means for adjusting Bernoulli effect forces on said air foil.

2. The device of claim 1, wherein said means for adjusting comprise moving bands arranged over at least part of a surface of said at least one blade.

3. The device of claim 2, wherein a plurality of said moving bands are used to cover said twisted leading edge.

4. The device of claim 3, wherein said moving bands cover approximately one half (½) the length of said at least one blade.

5. The device of claim 2, further comprising an interface between said at least one moving band and said surface of said at least one blade.

6. The device of claim 5, wherein said interface comprises rollers.

7. The device of claim 6, wherein said rollers are asymmetrical to match said surface of said at least one blade to a desired travel path of at least one said moving band.

8. The device of claim 5, wherein said interface further comprise ball bearings mounted on said surface of said at least one blade.

9. The device of claim 3, further comprising multiple motivating means for controlling speed of movement for said at least one moving band.

10. The device of claim 9, wherein said motivating means are controlled by a central computer controller.

11. The device of claim 10, wherein central computer controller operates responsive to detection of dynamic operating and environmental conditions at said at least one blade.

12. The device of claim 1, further comprising an annular support interfacing with said at least one blade.

13. The device of claim 12, further comprising an interface between said support and said at least one blade.

14. The device of claim 13, wherein said interface comprises at least one roller bearing.

15. A method of operating a wind turbine having a twisted leading edge multiple blade design, said method comprising the steps of:
a) rotating said blades about a center nacelle so that each said blade constitutes an air foil driven by wind impacting said turbine; and
b) adjusting lift characteristics of said air foils without adjusting wind speed.

16. The method of claim 15, wherein the step of adjusting lift characteristics comprises a sub-step of moving bands over at least a portion of a surface of at least one twisted leading edge blade.

17. The method of claim 15, wherein torque developed on said wind turbine is increased.

18. The method of claim 15, wherein said torque on said wind turbine is decreased.

19. The method of claim 16, wherein said moving bands are operated so as to create a uniformly moving surface over said at least one twisted leading edge blade.

20. The method of claim 16, wherein said moving bands are operated at different speeds along a length of said at least one twisted leading edge blade to compensate for differences in blade speed along the length of said at least one twisted leading edge blade.
